(19) United States
(12) Patent Application Publication
(10) Pub. No.: US 2013/0187059 A1
(43) Pub. Date: Jul. 25, 2013

(54) RADIATION IMAGE CAPTURING SYSTEM AND RADIATION IMAGE CAPTURING APPARATUS

(71) Applicant: Taketoh MURAOKA, Saitama-shi (JP)

(72) Inventor: Taketoh MURAOKA, Saitama-shi (JP)

(73) Assignee: Konica Minolta Medical & Graphic, Inc., Tokyo (JP)

(21) Appl. No.: 13/737,133

(22) Filed: Jan. 9, 2013

(30) Foreign Application Priority Data
Jan. 23, 2012 (JP) 2012-010617

(51) Int. Cl. G01T 1/17

(52) U.S. Cl. CPC G01T 1/17
USPC 250/394

(57) ABSTRACT

A radiation image capturing system which includes a radiation image capturing apparatus including a plurality of scanning lines and a plurality of signal lines, a plurality of radiation detection elements, a scanning drive unit, switch units, reading circuits and a control unit and a console including a notification unit. In the system, the control unit of the radiation image capturing apparatus starts or continues a reset process of the radiation detection elements to discharge the electric charges remaining in the radiation detection elements from inside of each of the radiation detection elements for next radiation image capturing when a series of processes for obtaining the image data is finished.

### BACKGROUND OF THE INVENTION

1. Field of the Invention

The present invention relates to a radiation image capturing system and a radiation image capturing apparatus.

2. Description of Related Art

There has been developed various types of radiation image capturing apparatuses including a so-called direct type radiation image capturing apparatus that generates electric charges through detection elements in response to the dosage of applied radiation such as X-rays and converts the electric charges into electric signals and a so-called indirect type radiation image capturing apparatus that uses a scintillator or the like to convert the applied radiation into electromagnetic waves having other wavelengths such as visible light and then generates electric charges through photoelectric conversion elements such as photodiodes in response to the energy of the electromagnetic wave having been converted and applied to convert the electric changes into electric signals (that is, image data). In the following description of the present invention, the detection. elements in the direct type radiation image capturing apparatus and the photoelectric conversion elements in the indirect type radiation image capturing apparatus will be collectively referred to as radiation detection elements.

Such types of radiation image capturing apparatus are known as FPD (Flat Panel Detector). In the conventional art, this radiation image capturing apparatus has been designed as a so-called exclusive type formed integrally with a support base (see Japanese Patent Application Laid Open Publication No. H9-73144, for example). However, in recent years, portable radiation image capturing apparatuses wherein radiation detection elements and others are incorporated in a casing for easy transportation have been developed and put into practical use (see Japanese Patent Application Laid Open Publication No. 2006-058124 and Japanese Patent Application Laid Open Publication No. H6-342099, for example).

In the aforementioned radiation image capturing apparatus, a plurality of radiation detection elements 7 are normally arranged in a two-dimensional array (matrix) on a detecting section P, and each radiation detection element 7 is connected with a switch unit formed of a thin film transistor (hereinafter called “TFT”) 8, as shown in FIG. 3 to be described later, for example.

Then, radiation image capturing is normally carried out by applying radiation to a radiation image capturing apparatus from a radiation source of a radiation generator via a body of a subject or the like, that is, a target body.

After application of radiation to the radiation image capturing apparatus is finished, on-voltage is applied sequentially to each of the lines L1 to Lx of a scanning line 5 from a gate driver 15b so that each TFT 8 is sequentially turned on. The electric charges which are generated and accumulated in each radiation detection element 7 by application of radiation is sequentially discharged to each of signal lines 6. Then, these electric charges are read out as image data D by each reading circuit 17.

In some cases, the radiation image capturing apparatus cannot perform the next radiation image capturing immediately after a series of processes for obtaining the image data D such as a reading process of image data D is finished as described above. That is, in some radiation image capturing apparatuses, an operator such as a radiology technician is not allowed to apply radiation to the radiation image capturing apparatus for the next radiation image capturing immediately after a series of processes for obtaining image data D is finished.

In such cases, the radiation image capturing apparatus has a period of time which is one to several seconds and for which the operator is not allowed to apply radiation to the radiation image capturing apparatus despite that a series of processes for obtaining image data D is finished. Hereinafter, this period of time will be called waiting time.

When there is waiting time which is approximately one to several seconds for each radiation image capturing as described above, an operator such as a radiology technician needs to wait to apply radiation for the waiting time for each image capturing in a case where radiation image capturing needs to be performed one after another as in chest X-ray radiography in mass-screening, for example.

In such condition, the operator is put on hold during the waiting time repeatedly and feels these periods of time long and bothersome even if each waiting time is a short period of time which is approximately one to several seconds. Therefore, the radiation image capturing system including the radiation image capturing apparatus is inconvenient for an operator to use, the operability of the radiation image capturing system is worsen and the operator feels stressed.

For an operator such as a radiology technician, in a radiation image capturing apparatus and a radiation image capturing system using the radiation image capturing apparatus, it is desirable that radiation can be applied for the next radiation image capturing immediately after a series of processes for obtaining image data D is finished in the radiation image capturing apparatus.

### SUMMARY OF THE INVENTION

The present invention was made in consideration of the above problems and an object of the present invention is to provide a radiation image capturing system and a radiation image capturing apparatus in which radiation can be immediately applied for the next radiation image capturing when a series of processes for obtaining image data is finished in the radiation image capturing apparatus.

In order to solve the above problems, according to one aspect of a preferred embodiment of the present invention, there is provided a radiation image capturing system which includes a radiation image capturing apparatus including a plurality of scanning lines and a plurality of signal lines arranged to cross each other, a plurality of radiation detection elements arranged in a two-dimensional array, a scanning drive unit which switches a voltage to be applied to the scanning lines between an on-voltage and an off-voltage, switch units which are connected to each of the scanning lines so as to discharge electric charges accumulated in the radiation detection elements to the signal lines when the on-voltage is applied, reading circuits which read out the electric charges discharged to the signal lines, and a control unit which controls at least the scanning drive unit and the reading circuits to read out the electric charges discharged from the radiation detection elements as image data, and a console including a notification unit, wherein the console sends an image capturing start instruction signal to the radiation image capturing apparatus, wherein the control unit of the radiation image capturing apparatus starts or continues a reset process of the radiation detection elements to discharge the electric charges remaining in the radiation detection elements from inside of each of the radiation detection elements for next radiation image capturing when a series of processes for obtaining the image data is finished, the control unit of the radiation image capturing apparatus stops the reset process of the radiation detection elements, shifts to a process for the next radiation image capturing and sends a shift signal indicating shift to the process for the next radiation image capturing to the console when the image capturing start instruction signal for the next image capturing is sent from the console, and the console notifies that radiation image capturing is possible via the notification unit when the console receives the shift signal from the radiation image capturing apparatus.

### BRIEF DESCRIPTION OF THE DRAWINGS

The above and other objects, advantages and features of the present invention will become more fully understood from the detailed description given hereinafter and the appended drawings which are given byway of illustration only, and thus are not intended as a definition of the limits of the present invention, and wherein:

FIG. 1 is a sectional view of a radiation image capturing apparatus;

FIG. 2 is a plan view illustrating a configuration of a substrate of a radiation image capturing apparatus;

FIG. 3 is a block diagram showing an equivalent circuit of a radiation image capturing apparatus;

FIG. 4 is a diagram illustrating a configuration example of a radiation image capturing system of the embodiment established in a image capturing room or the like;

FIG. 5 is a diagram illustrating a configuration example of a radiation image capturing system of the embodiment which is established in a visiting car;

FIG. 6 is a timing chart explaining a reset process of each radiation detection element which is performed by sequentially applying on-voltage to respective scanning line;

FIG. 7 is a timing chart explaining a reset process of each radiation detection element which is performed by simultaneously applying on-voltage to the scanning lines;

FIG. 8 is a diagram explaining that each electric charge having leaked from a radiation detection element through a TFT is read out as leak data;

FIG. 9 is a timing chart showing timing at which on-voltage is sequentially applied to each of the scanning lines when a reading process of image data for detecting irradiation start is performed in the non-cooperation method;

FIG. 10 is a timing chart showing timing at which on-voltage is sequentially applied to each scanning line when a reading process of offset data is performed by repeating process sequence which is the same as the process sequence shown in FIG. 9;

FIG. 11 is a diagram showing procedure, each process and such like of radiation image capturing in a conventional radiation image capturing apparatus and a radiation image capturing system;

FIG. 12 is a diagram showing procedure, each process and such like of radiation image capturing in a radiation image capturing apparatus and a radiation image capturing system of the present invention; and

FIG. 13 is a diagram showing procedure, each process and such like of radiation image capturing in a radiation image capturing apparatus and a radiation image capturing system of the present invention.

### DETAILED DESCRIPTION OF THE PREFERRED EMBODIMENT

Hereinafter, an embodiment of a radiation image capturing system and a radiation image capturing apparatus of the present invention will be described with reference to drawings.

The following describes a so-called indirect type radiation image capturing apparatus that is provided with a scintillator or the like and converts applied radiation into electromagnetic waves of other wavelengths such as visible light to obtain electric signals as a radiation image capturing apparatus which is used in the radiation image capturing system. However, the present invention is also applicable to the so-called direct type radiation image capturing apparatus that detects radiation directly by radiation detection elements without using a scintillator or the like.

Further, though the following describes a case where the radiation image capturing apparatus is a so-called portable type, the present invention is also applicable to the so-called exclusive device type radiation image capturing apparatus which is formed integrally with the support base and such like.

### [Radiation Image Capturing Apparatus]

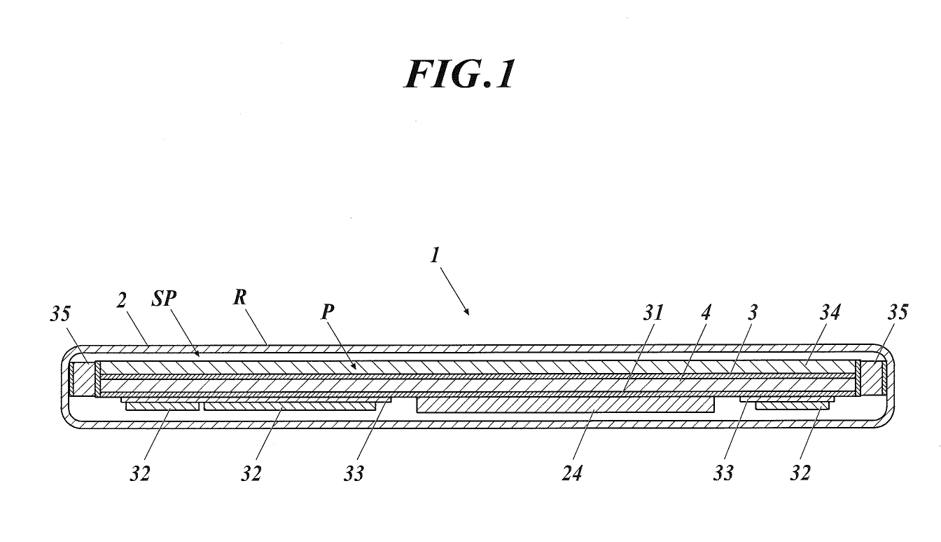

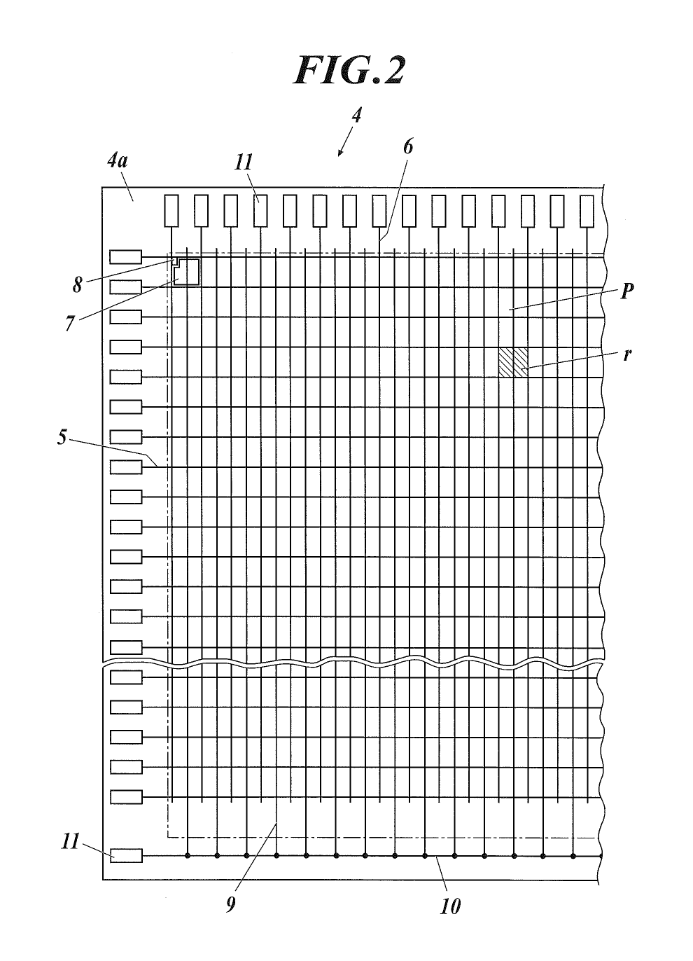

First, a configuration and others of a radiation image capturing apparatus which is used in a radiation image capturing system of the embodiment will be described. FIG. 1 is a sectional view of a radiation image capturing apparatus of the embodiment and FIG. 2 is a plan view illustrating a configuration of a substrate of a radiation image capturing apparatus.

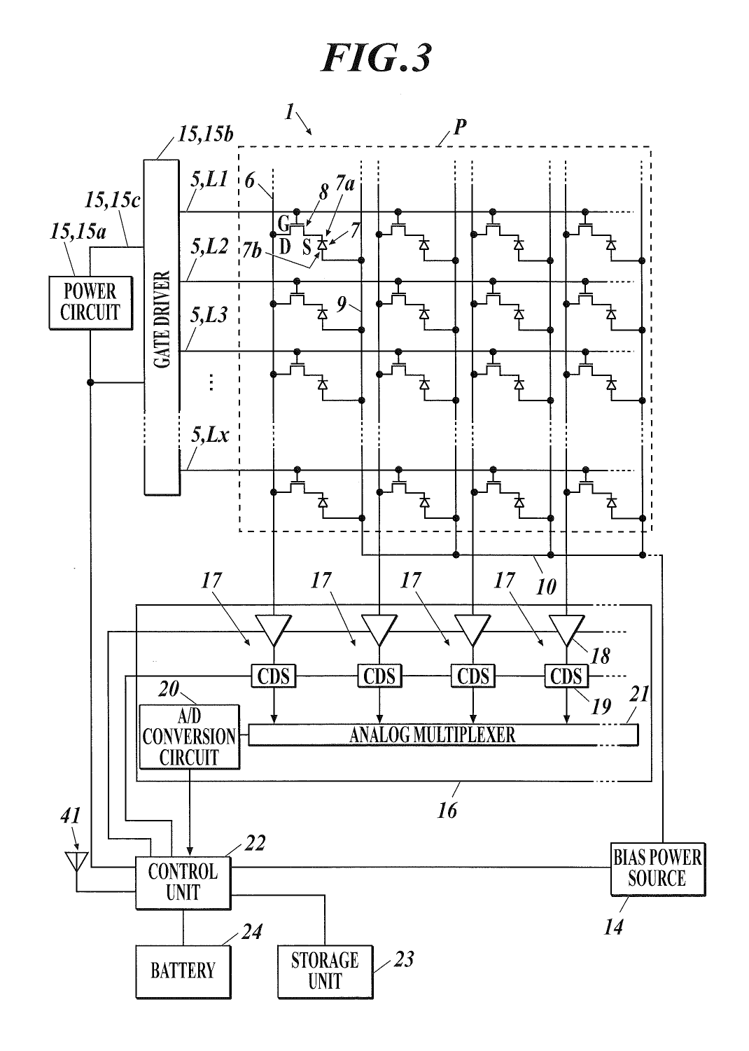

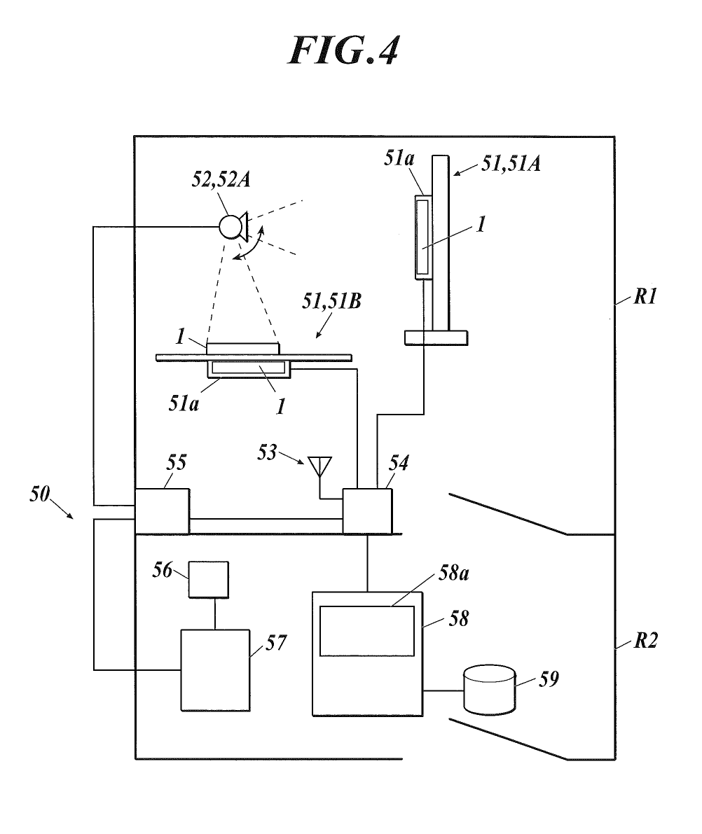

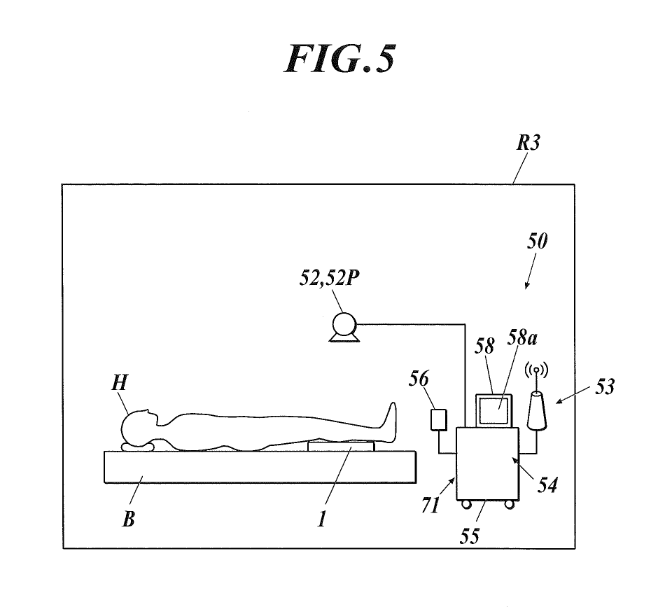

In the radiation image capturing apparatus 1, as shown in FIG. 1, a sensor panel SP including a scintillator 3 and a substrate 4 is incorporated in a casing 2 which is formed of a carbon board including a radiation incidence surface R, the surface to which radiation is applied, for example. Also, though not illustrated in FIG. 1, an antenna device 41 (see after-mentioned FIG. 3) which is a communication unit sending image data D and others to an after-mentioned console 58 (see FIGS. 4 and 5) in a wireless system is provided in the casing 2 in the embodiment.

Further, though not shown in FIG. 1, the radiation image capturing apparatus 1 of the embodiment includes a connector on a side surface of the casing 2 or the like and can send a signal and data to the console 58 via the connector in a wired system, for example. Therefore, the connector also functions as a communication unit of the radiation image capturing apparatus 1.

As shown in FIG. 1, a base 31 is disposed in the casing 2, and a substrate 4 is provided at a radiation incidence surface R side (hereinafter, simply called upper side) of the base 31 via a thin lead plate or the like which is not shown in the drawings. Then, at the upper side of the substrate 4, the scintillator 3 which converts the applied radiation into light such as visible light is provided on a scintillator substrate 34 so as to face the substrate 4.

Further, a PCB substrate 33 equipped with electronic parts 32 and a battery 24 are attached to the lower side of the base 31, for example. In such way, the sensor panel SP is formed of the base 31, the substrate 4 and others. Also, in the embodiment, a cushioning material 35 is provided between each lateral side of the sensor panel SP and the casing 2.

In the embodiment, the substrate 4 is formed of a glass substrate. As shown in FIG. 2, a plurality of scanning lines 5 and a plurality of signal lines 6 are arranged so as to cross each other on the upper surface (that is, the surface facing the scintillator 3) 4a of the substrate 4. A radiation detection element 7 is provided in each of small regions r partitioned by a plurality of scanning lines 5 and a plurality of signal lines 6 on the surface 4a of the substrate 4.

As described above, a detecting section P is defined as the area including all of the small regions r which are partitioned by the scanning lines 5 and the signal lines 6 wherein a plurality of radiation detection elements 7 are provided respectively in the small regions r in a two-dimensional array (in matrix), that is, the entire region indicated by the one-dot chain line in FIG. 2. In the embodiment, photodiodes are used as the radiation detection elements 7. However, phototransistors can also be used, for example.

Here, a circuit structure of the radiation image capturing apparatus 1 will be described. FIG. 3 is a block diagram showing an equivalent circuit of the radiation image capturing apparatus 1 in the embodiment.

A source electrode 8s (see “S” in FIG. 3) of the TFT 8 which is a switch unit is connected to a first electrode 7a of each radiation detection element 7. A drain electrode 8d and a gate electrode 8g (see “D” and “G” in FIG. 3) of the TFT 8 are connected to a signal line 6 and a scanning line 5, respectively.

The TFT 8 is turned on when on-voltage is applied to the gate electrode 8g from an after-mentioned scanning drive unit 15 through the scanning line 5, and the electric charge accumulated in the radiation detection element 7 is discharged to the signal line 6 through the source electrode 8s and the drain electrode 8d. Further, the TFT 8 is turned off when off-voltage is applied to the gate electrode 8g through the scanning line 5. This suspends discharge of electric charge from the radiation detection element 7 to the signal line 6 so that the electric charge is accumulated inside the radiation detection element 7.

Also, as shown in FIGS. 2 and 3, a bias line 9 is connected to the second electrodes 7b of the radiation detection elements 7 for each line of the radiation detection elements 7 on the substrate 4, and the bias lines 9 are tied to a wiring 10 at positions outside the detecting section P of the substrate 4.

Then, the wiring 10 is connected to a bias power source 14 (see FIG. 3) via an input/output terminal 11 (also called a pad, see FIG. 2), and inverse bias voltage is applied from the bias power source 14 to the second electrode 7b of each radiation detection element 7 through the wiring 10 and each of the bias lines 9.

On the other hand, each scanning line 5 is connected to the gate driver 15b of the scanning drive unit 15 via a respective input/output terminal 11. In the scanning drive unit 15, on-voltage and off-voltage are supplied to the gate driver 15b through a wiring 15c from a power circuit 15a, and the gate driver 15b switches the voltage which is to be applied to each of the lines L1 through Lx of the scanning lines 5 between on-voltage and off-voltage.

Further, each signal line 6 is connected to a reading circuit 17 incorporated in a reading IC 16 via a respective input/output terminal 11. In the embodiment, each reading circuit 17 mainly includes an amplification circuit 18, a correlated dual sampling circuit 19 and such like. The reading IC 16 further incorporates an analog multiplexer 21 and an A/D conversion circuit 20. The correlated dual sampling circuit 19 is represented as CDS in FIG. 3.

In a reading process of image data D from each radiation detection element 7, when on-voltage is applied to a scanning line 5 from the gate driver 15b of the scanning drive unit 15 to turn on each of the TFTs 8, electric charge is discharged to a signal line 6 from inside of each radiation detection element 7 through its TFT 8. Then, in the amplification circuit 18 of each of the reading circuits 17, the voltage value corresponding to the amount of electric charge which flowed in from the radiation detection element 7 is outputted to the correlated dual sampling circuit 19 side.

The correlated dual sampling circuit 19 outputs, in downstream direction, the increase in the outputted value from the amplification circuit 18 between before and after the electric charge flows into the amplification circuit 18 from each of the radiation detection element 7 as image data D of analog value. Then, the outputted image data D is sequentially sent to the A/D conversion circuit 20 through the analog multiplexer 21, sequentially converted to image data D of digital value by the A/D conversion circuit 20 and sequentially outputted to a storage device 23 to be stored. This is how the reading process of image data D is performed.

The control unit 22 includes CPU (Central Processing Unit), ROM (Read Only Memory), RAM (Random Access Memory), a computer connected with an input/output interface and such like through a bus, FPGA (Field Programmable Gate Array) and such like which are not shown in the drawings. The control unit 22 can also be formed of an exclusive control circuit.

The control unit 22 controls operation of each functioning section of the radiation image capturing apparatus 1 by controlling the scanning drive unit 15 and the reading circuits 17 to perform the reading process of image data D as described above, for example.

Further, as shown in FIG. 3, the control unit 22 is connected with the storage unit 23 including SRAM (Static RAM), SDRAM (Synchronous DRAM) and others. Also, in the embodiment, the control device 22 is connected with the aforementioned antenna device 41 and a battery 24 for supplying power to each of the functioning sections such as the scanning drive unit 15, the reading circuits 17, the storage unit 23, and the bias power source 14.

Each process and such like in the radiation image capturing apparatus 1 at the time of radiation image capturing will be described after a configuration and such like of the radiation image capturing system 50 of the embodiment is described.

### [Radiation Image Capturing System]

Next, a configuration and such like of a radiation image capturing system 50 of the embodiment will be described. FIG. 4 is a diagram illustrating a configuration example of the radiation image capturing system 50 of the embodiment. FIG. 4 shows a case where the radiation image capturing system 50 is established in an image capturing room R1 or the like.

A bucky 51 is set in the image capturing room R1 and the bucky 51 can be used by loading the aforementioned radiation image capturing apparatus 1 in a cassette holding section (also called a cassette holder) 51a thereof. Here, FIG. 4 shows a case where a bucky 51A for standing position radiation image capturing and a bucky 51B for recumbent position radiation image capturing are set as buckies 51. However, only one of the buckles 51 may be provided, for example.

As shown in FIG. 4, the image capturing room R1 is provided with at least one radiation source 52A which applies radiation to the radiation image capturing apparatus 1 loaded in the bucky 51 via the target body. In the embodiment, radiaton can be applied to both of the bucky 51A for standing position radiation image capturing and the bucky 51B for recumbent position radiation image capturing by moving the position of the radiation source 52A or by changing the application direction of radiation.

The image capturing room R1 is provided with a relaying device (also called a base station, for example) 54 for relaying communication between devices in the image capturing room R1 and devices outside the image capturing room R1, for example. Here, in the embodiment, the relaying device 54 is provided with a wireless antenna (also called an access point) 53 so that the radiation image capturing apparatus 1 can send and receive image data D, signals and the like in a wireless system.

Also, the relaying device 54 is connected with the radiation generator 55 and the console 58, and the relaying device 54 incorporates a converter (not shown in the drawings) that converts signals or the like for LAN (Local Area Network) communication which are to be sent from the radiation image capturing apparatus 1, the console 58 and the like to the radiation generator 55 into signals or the like for the radiation generator 55 and that also performs the reverse conversion.

In the embodiment, a front room (also called an operation room and the like) R2 is provided with an operational table 57 of the radiation generator 55, and the operational table 57 is provided with an exposure switch 56 for an operator such as a radiology technician to operate so as to instruct the radiation generator 55 to start radiation irradiation and the like. The radiation generator 55 applies radiation from the radiation source 52 when the exposure switch 56 is operated by an operator, and carries out various controls such as adjusting the radiation source 52 so as to apply appropriate dosage of radiation.

As shown in FIG. 4, in the embodiment, a console 58 which consists of a computer and the like is provided in the front room R2. Here, the console 58 can be provided in the image capturing room R1, outside the front room R2, in another room and the like to be set in an appropriate place.

Further, the console 58 is provided with a display section 58a which is configured by including CRT (Cathode Ray Tube), LCD (Liquid Crystal Display) or the like, and is also provided with an input unit such as a mouse and a keyboard which are not shown in the drawings . Also, a storage unit 59 which includes HDD (Hard Disk Drive) and the like is connected to or built in the console 58.

On the other hand, as shown in FIG. 5, the radiation image capturing apparatus 1 can also be used by itself without being loaded in the bucky 51. For example, in a case where a patient H cannot rise from a bed B in a patient's room R3 and thus cannot go to the image capturing room R1, as shown in FIG. 5, the radiation image capturing apparatus 1 can be taken into the patient's room R3 to be used by being placed between the bed B and the patient body or by being held against the patient body.

In addition, in a case where the radiation image capturing apparatus 1 is used in the patient's room R3 or the like, instead of the radiation generator 55 which is installed in the aforementioned image capturing room R1, as shown in FIG. 5, a so-called portable radiation generator 55 is taken into the patient's room R3 by being mounted on the visiting car 71, for example.

In this case, radiation 52P of the portable radiation generator 55 can be applied in an arbitrary direction and the radiation can be applied from an appropriate distance or in an appropriate direction to the radiation image capturing apparatus 1 which is placed between the bed B and the patient body or held against the patient body.

Further, in this case, a relaying device 54 provided with a wireless antenna 53 is built in the radiation generator 55, and as described above, the relaying device 54 relays communication between the radiation generator 55 and the console 58, communication between the radiation image capturing apparatus 1 and the console 58, transmission of image data D and the like.

Here, as shown in FIG. 4, the radiation image capturing apparatus 1 can be used by being placed between a patient body (not shown in the drawings) which is recumbent on the bucky 51B for recumbent position radiation image capturing in the image capturing room R1 and the bucky 51B for recumbent position radiation image capturing or by being held against the patient body on the bucky 51B for recumbent position radiation image capturing. In this case, either of the portable radiation 52P and the radiation source 52A which is installed in the image capturing room R1 can be used.

In the embodiment, the console 58 also functions as an image processing apparatus . When image data D and the like are sent from the radiation image capturing apparatus 1, the console 58 carries out accurate image processing such as offset correction, gain correction, defect pixel correction, tone processing according to the captured part and the like on the basis of the sent image data D and the like to generate a radiation image.

Here, the image processing apparatus can be configured as a different apparatus from the console 58. Further, instead of being formed as a desktop computer or the like as shown in FIGS. 4 and 5, the console 58 can be formed as a mobile device (not shown in the drawings) which an operator such as a radiology technician carries with him or her, for example.

Further, in the embodiment, a display section 58a of the console 58 functions as a notification unit, and this will be explained later. Here, it is also possible to use a speaker of the console 58 (including the console 58 configured as a mobile device) as a notification unit and carry out notification by sound from the speaker, or to provide the console 58 with a light emitting unit as a notification unit and carry out notification by emitting light from the light emitting unit, for example.

### [Process in a Radiation Image Capturing System at the Time of Radiation Image Capturing]

Hereinafter, each process performed by a radiation image capturing apparatus 1 and a console 58 at the time of radiation image capturing will be described. Operation of the radiation image capturing apparatus 1 and the radiation image capturing system 50 of the embodiment is also described.

In the embodiment, the console 58 can obtain image capturing order information which is previously registered from an external HIS (Hospital Information System) and RIS (Radiology Information System) which are connected to the console 58 via a network or the like. Though not shown in the drawings, name of a patient who is to be a target of radiation image capturing and image capturing conditions such as an image capturing part (chest or cervical spine) and an image capturing direction (front side or lateral side) are specified in the image capturing order information, for example.

Then, an operator such as a radiology technician obtains the image capturing order information regarding a series of radiation image capturing to be conducted next from HIS or RIS to the console 58, for example. In the embodiment, when the operator selects the image capturing order information regarding radiation image capturing to be conducted next on the console 58, the console 58 sends an instruction signal to start image capturing to the radiation image capturing apparatus 1 at that time.

When the control unit 22 of the radiation image capturing apparatus 1 receives the instruction signal to start image capturing from the console 58, the control unit 22 controls each of the functioning sections so as to start a series of processes in preparation for radiation image capturing.

There are mainly two types of image capturing methods in radiation image capturing, one of which is an image capturing method (hereinafter, called the cooperation method) wherein radiation image capturing is carried out by exchanging signals and others between the radiation image capturing apparatus 1 and the radiation generator 55 (see FIGS. 4 and 5) and the other of which is an image capturing method (hereinafter, called the non-cooperation method) wherein radiation image capturing is carried out by the radiation image capturing apparatus 1 detecting the start of radiation irradiation by itself without exchanging signals and others between the radiation image capturing apparatus 1 and the radiation generator 55.

When radiation image capturing is carried out in the cooperation method, normally, the control unit 22 of the radiation image capturing apparatus 1 repeatedly performs a reset process of each of the radiation detection elements 7 for discharging the electric charge remaining in each of the radiation detection elements 7 from inside the radiation detection element 7 to the signal line 6 and to the downstream thereof as the first process in preparation for radiation image capturing.

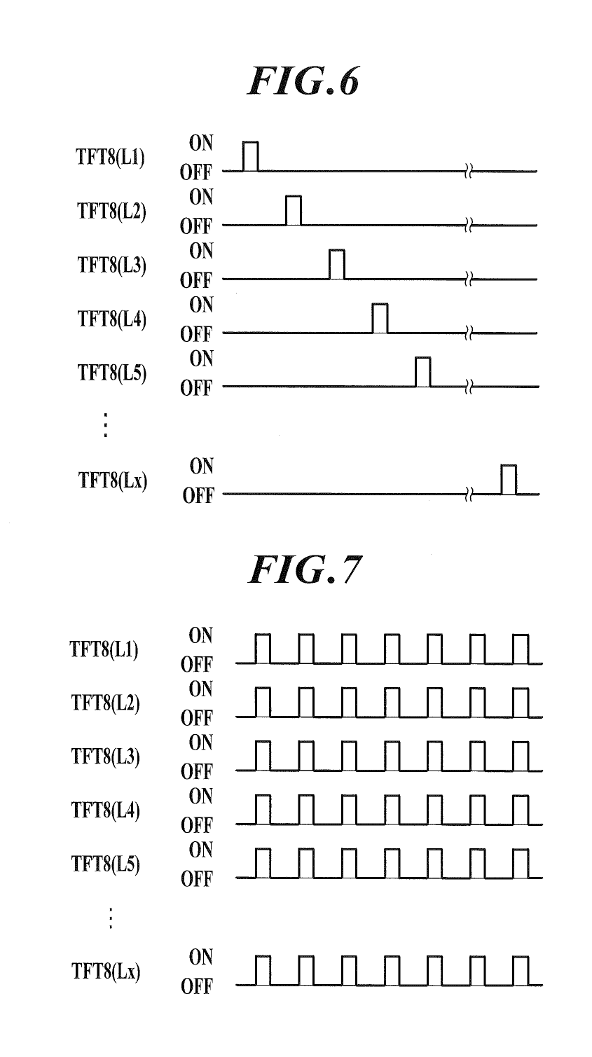

In this case, similarly to the case adopting the following other method, the reset process of each of the radiation detection elements 7 can be performed by sequentially applying on-voltage to each of the lines L1 to Lx of the scanning lines 5 from the gate driver 15b (see FIG. 3) of the scanning drive unit 15 as shown in FIG. 6, for example. Alternatively, the reset process can be performed by simultaneously applying on-voltage to each of the lines L1 to Lx of the scanning lines 5 from the gate driver 15b as shown in FIG. 7, for example.

Then, when an operator such as a radiology technician operates the exposure switch 56 (see FIGS. 4 and 5) of the radiation generator 55 (the first operation), an irradiation start signal is sent from the radiation generator 55 to the radiation image capturing apparatus 1. When receiving the irradiation start signal, the control unit 22 of the radiation image capturing apparatus 1 appropriately stops the reset process of each of the radiation detection elements 7 and when it becomes possible to receive radiation irradiation, the control unit 22 sends an interlock release signal to the radiation generator 55. Then, the radiation generator 55 applies radiation to the radiation image capturing apparatus 1 from the radiation source 52 (see FIGS. 4 and 5) only after receiving the interlock release signal.

On the other hand, as for a case where radiation image capturing is performed in the non-cooperation method, various methods are suggested as methods for detecting radiation irradiation start by the radiation image capturing apparatus 1 itself. Any of the methods can be adopted in the embodiment.

As a method for detecting radiation irradiation start by the radiation image capturing apparatus 1 itself in the non-cooperation method, a current detection unit (not shown in the drawings) which detects a value of current flow through bias lines 9 and a wiring 10 (see FIG. 3 and others) can be provided with the bias line 9 and the wiring 10 as described in the specification of the U.S. Pat. No. 7,211,803 and the Japanese Patent Application Laid Open Publication No. 2009-219538, for example.

In this case, when radiation irradiation of the radiation image capturing apparatus 1 is started, electric charge is generated inside each radiation detection element 7 and flows from each radiation detection element 7 to a bias line 9. As a result, there is an increase in current running through the bias lines 9 and the wiring 10, and thus radiation irradiation start can be detected on the basis of a current value detected by the current detection unit by providing a threshold value for the detected current value, for example.

Also, instead of providing such current detection unit, an X-ray sensor or the like can be provided to the radiation image capturing apparatus 1 so that the radiation image capturing apparatus 1 itself detects the radiation irradiation start on the basis of the measured value of the X-ray sensor.

Further, there has been found methods for detecting radiation irradiation start by the radiation image capturing apparatus 1 itself by using each functional section which is already provided in the radiation image capturing apparatus 1 without providing new units such as the current detection unit and the X-ray sensor in the radiation image capturing apparatus 1 as described above. For the detail of such detection methods, refer to WO 2011/135917 and WO 2011/152093 which the applicant and others of the present invention previously submitted, for example.

To provide brief description, in these detection methods, the scanning drive unit 15 and each of the reading circuits 17 (see FIG. 3) are activated to repeatedly perform a reading process of image data prior to radiation image capturing (that is, before radiation is applied to the radiation image capturing apparatus 1), for example (see WO 2011/152093 and others). Hereinafter, the image data which is read out prior to the radiation image capturing will be called image data d for irradiation start detection, for distinction from the aforementioned image data D which is read out as a main image.

In this configuration, when radiation irradiation to the radiation image capturing apparatus 1 is started, electric charge is generated in each radiation detection element 7 by the radiation application and is read out as image data d for irradiation start detection. Thus, the value of image data d for irradiation start detection which is read out increases rapidly when radiation irradiation to the radiation image capturing apparatus 1 is started. Therefore, radiation irradiation start can be detected by the radiation image capturing apparatus 1 itself utilizing the phenomenon that the value of image data d for irradiation start detection increases.

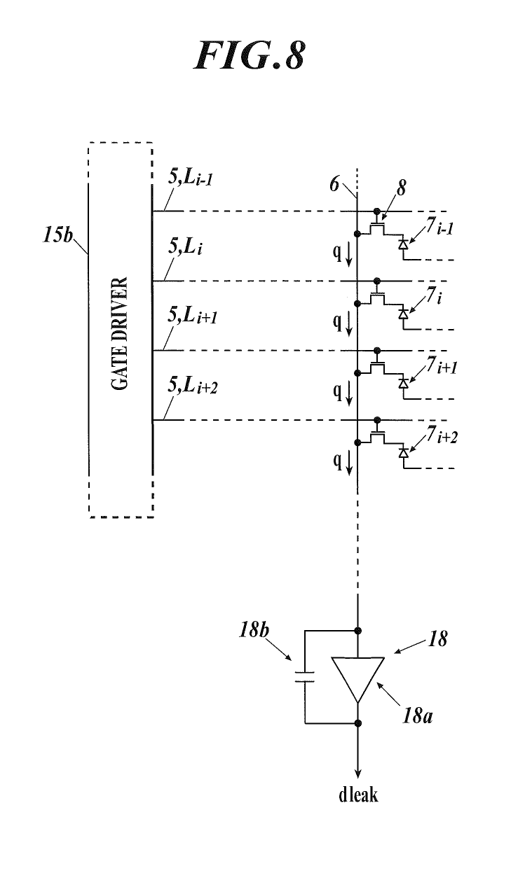

Further, there can be a configuration in which a reading process of leak data d leak is repeatedly performed by activating each reading circuit 17 and others prior to radiation image capturing (see WO 2011/135917). As shown in FIG. 8, the leak data “d leak” is data equivalent to a total value of electric charge q for each of the signal lines 6 which leaked from respective radiation detection elements 7 through their TFTs 8 which are turned off while off-voltage is being applied to each scanning line 5.

That is, data is read out in each reading circuit 17 in the reading process of leak data d leak similarly as in the reading process of image data D and image data d for irradiation start detection. At that time, on-voltage is not applied (that is, TFT 8 is not turned on) from the gate driver 15b to the scanning lines 5 differently from the reading process of image data D and image data d for irradiation start detection.

In such configuration as well, it is known that the value of leak data d leak which is read out rapidly increases when radiation irradiation to the radiation image capturing apparatus 1 is started because there is an increase in electric charge q (see FIG. 8) which leaks to a signal line 6 from inside of each radiation detection element 7 through its TFT 8. Thus, radiation irradiation start can be detected by the radiation image capturing apparatus 1 itself utilizing the phenomenon that there is an increase in value of leak data d leak.

Here, instead of performing radiation image capturing by another procedure in a case of cooperation method or providing a current detection unit or an X-ray sensor as mentioned above or performing the reading process of image data d for irradiation start detection or leak data d leak in a case of non-cooperation method, other methods can be used to detect radiation irradiation start by the radiation image capturing apparatus 1 itself and the present invention can be applied to the cases using other methods as well.

As described above, the control unit 22 of the radiation image capturing apparatus 1 starts a series of processes for radiation image capturing when receiving the above image capturing start instruction signal from the console 58. Specifically, in the cooperation method, a reset process of each radiation detection element 7 is started as described above, for example. In the non-cooperation method, a current detection unit or an X-ray sensor is operated or a reading process of image data d for irradiation start detection or leak data d leak is started, for example.

Then, in the cooperation method, the control unit 22 of the radiation image capturing apparatus 1 sends an interlock release signal to the radiation generator 55 from the radiation image capturing apparatus 1 as described above and at the same time, applies off-voltage from the gate driver 15b to all the scanning lines 5 and turns off each TFT 8 to shift to a state (hereinafter, called electric charge accumulation state) where electric charge generated in each radiation detection element 7 by radiation irradiation is appropriately accumulated in each radiation detection element 7.

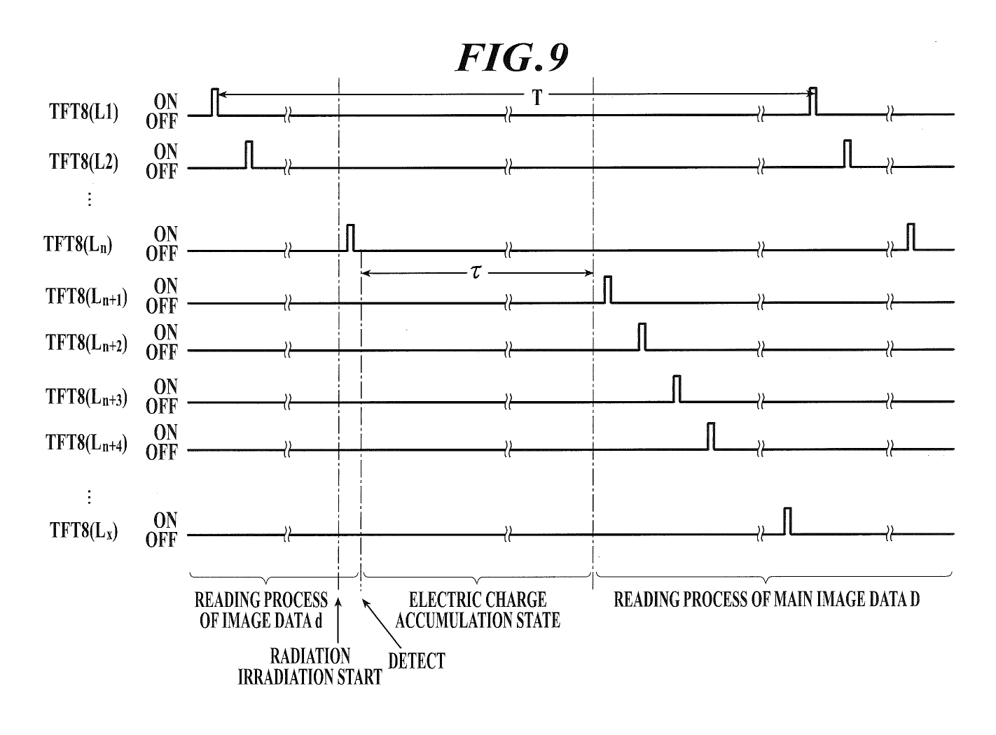

In a case where the reading process of image data d for irradiation start detection is performed in the non-cooperation method, as shown in FIG. 9, the control unit 22 of the radiation image capturing apparatus 1 turns off each TFT 8 to shift to the electric charge accumulation state similarly as in the above when radiation irradiation start is detected on the basis of the value of image data d for irradiation start detection which is read out by applying on-voltage from the gate driver 15b to a scanning line 5 (the line Ln of scanning lines 5 in FIG. 9).

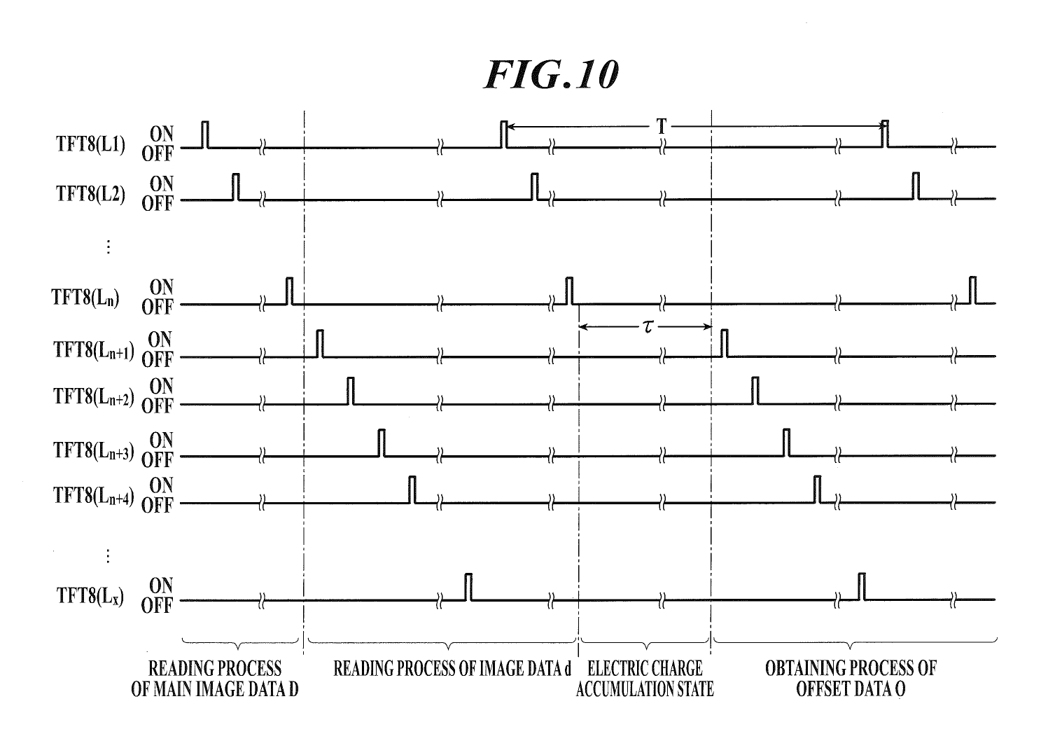

In FIG. 9 and after-mentioned FIG. 10, the image data d for irradiation start detection is described merely as “image data d” and the image data D as a main image is described as “main image data D” for short.

Then, the control unit 22 of the radiation image capturing apparatus 1 starts a reading process of image data D as a main image after continuing the electric charge accumulation state for a predetermined duration time τ (see FIG. 9) from the detection of radiation irradiation start, for example.

In a case of non-cooperation method in the embodiment, as shown in FIG. 9, the reading process of image data D as a main image is performed by starting on-voltage application from a scanning line 5 (the line Ln+1 of the scanning lines 5 in the case of FIG. 9) to which on-voltage is to be applied next to the scanning line 5 (the line Ln of the scanning lines 5 in the case of FIG. 9) to which on-voltage was applied when or immediately before the radiation irradiation start is detected, and by sequentially applying on-voltage from the gate driver 15b to each scanning line 5.

However, not limited to this , the reading process of image data D as a main image can be performed by starting on-voltage application from the first line L1 of the scanning lines 5 to sequentially apply on-voltage to each of the lines L1 through Lx of the scanning lines 5 similarly as in the cooperation method, for example.

On the other hand, when the reading process of image data D as a main image is finished as mentioned above, the control unit 22 of the radiation image capturing apparatus 1 subsequently performs a reading process of offset data O. The reading process of offset data O can be carried out prior to radiation image capturing, for example.

When the reading process of image data D as a main image is performed as described above, as shown in FIG. 9, so called dark electric charge (also called dark current flow or the like) which is always generated in each radiation detection element 7 is accumulated in each radiation detection element 7 as well as electric charge generated by radiation irradiation because TFT 8 has been turned off during a period of time T (hereinafter, this period of time T is called an effective accumulation time T) including the duration time τ of the electric charge accumulation state before the reading process of image data D.

Therefore, the image data D which is read out includes offset caused by dark electric charge accumulated in each radiation detection element 7 during the effective accumulation time T in addition to so-called real image data D* which is caused by the electric charge generated by radiation irradiation. The reading process of offset data O is a process of reading out offset caused by the dark electric charge superimposed on the image data D as offset data O.

In the embodiment, the control unit 22 of the radiation image capturing apparatus 1 performs the reading process of offset data O by repeating the same process sequence as the process sequence to the reading process of image data D as a main image, though not shown in the drawings.

That is, when the reading process of image data D is finished, the control unit 22 performs the reset process of each radiation detection element 7 in the cooperation method and performs the reading process of image data d for irradiation start detection or leak data d leak in the non-cooperation method, for example. In the case shown in FIG. 9, for example, a reading process of image data d for irradiation start detection is performed after the reading process of image data D as a main image by sequentially applying on-voltage to each scanning line 5 at the same timing as the reading process of image data d for irradiation start detection before radiation image capturing, as shown in FIG. 10.

Then, off-voltage is applied from the gate driver 15b to each of the lines L1 through Lx of the scanning lines 5 to shift to the electric charge accumulation state. Radiation is not applied to the radiation image capturing apparatus 1 in the reading process of offset data O. Then, similarly as in the above, the reading process of offset data O is performed after continuing the electric charge accumulation state for a predetermined duration time τ, by sequentially applying on-voltage to each scanning line 5 at the same timing as the reading process of image data D.

In such configuration, the effective accumulation time T before the reading process of image data D as a main image becomes the same time T as the effective accumulation time T before the reading process of offset data O in each scanning line 5. The same amount of dark electric charge is accumulated in each radiation detection element 7 if the period of time for which TFT 8 is being turned off, that is, the effective accumulation time is the same.

Therefore, by the above configuration, offset caused by the dark electric charge superimposed on image data D can be the same value as the offset data O. Then, by subtracting the offset data O from the image data D as a main image in a following image processing, the offset caused by the dark electric charge superimposed on image data D and offset data O cancel out each other and the real image data D* caused only by the electric charge generated by radiation irradiation can be calculated.

In the embodiment, when a series of processes for obtaining the image data D (to be precise, the real image data D*, the same shall apply hereinafter), that is, the reading process of image data D as a main image and the reading process of offset data O are finished as described above, the control unit 22 of the radiation image capturing apparatus 1 sends the image data D and the offset data O which are read out to an external image processing apparatus which is not shown in the drawings. In a case where the console 58 also acts as an image processing apparatus, the image data D and others are sent to the console 58.

### [Problems in a Conventional Radiation Image Capturing System]

As mentioned above, there is a case where the aforementioned predetermined waiting time exists during a period from when a series of processes are finished until the radiation source 52 is allowed to apply radiation for the next radiation image capturing because the radiation image capturing apparatus cannot carry out the next radiation image capturing immediately after a series of processes for obtaining the image data D is finished.

Then, as mentioned above, having the above waiting time even if it is a short time of approximately one to several seconds has caused an operator such as a radiology technician to feel bothersome in operating the radiation image capturing system.

Due to the configuration of the radiation image capturing apparatus, it is possible in some cases and impossible in other cases to receive radiation irradiation for the next image capturing while sending the image data D and offset data O. In the latter case (that is, when it is impossible to receive radiation irradiation), the time when a series of processes for obtaining the above image data D is finished is the time when a sending process of image data D and others is finished.

In a case where radiation irradiation can be received for the next image capturing while sending the image data D and others, the time when a series of processes for obtaining the above image data D is finished can be the following two types of time.

That is, when the reading process of offset data O is performed after the reading process of image data D as shown in FIG. 10, the time when a series of processes for obtaining image data D is finished is the time when the reading process of offset data O is finished. When the reading process of offset data O is performed previously (that is, prior to the radiation image capturing or prior to the reading process of image data D), the time when a series of processes for obtaining image data D is finished is the time when the reading process of image data D as a main image is finished.

The inventor of the present invention has studied on why the radiation image capturing apparatus cannot perform the next radiation image capturing immediately after a series of processes for obtaining the image data D is finished causing waiting time in a conventional radiation image capturing system and a radiation image capturing apparatus, as described above.

Then, the reason was found to be that the conventional radiation image capturing apparatus once shifts to a standby state, that is, a state of not performing a reading process of data nor a reset process of each radiation detection element 7 for reducing the power consumption or the like when a series of processes for obtaining the image data D is finished.

When the radiation image capturing apparatus is configured so as to shift to such standby state after a series of processes, as mentioned above, an operator such as a radiology technician selects and inputs image capturing order information for the next image capturing on the console 58, and when an image capturing start instruction signal is sent from the console 58 to the radiation image capturing apparatus, the radiation image capturing apparatus starts the reset process of each radiation detection element 7 to remove the electric charge remaining in each radiation detection element 7 at that time.

Then, a period of time which is approximately one to several seconds being required for the reset process of the radiation detection elements 7 was found to be the above waiting time. The following description takes a case where the time when a series of processes for obtaining image data D is finished is the time when sending process of image data D and others is finished as an example.

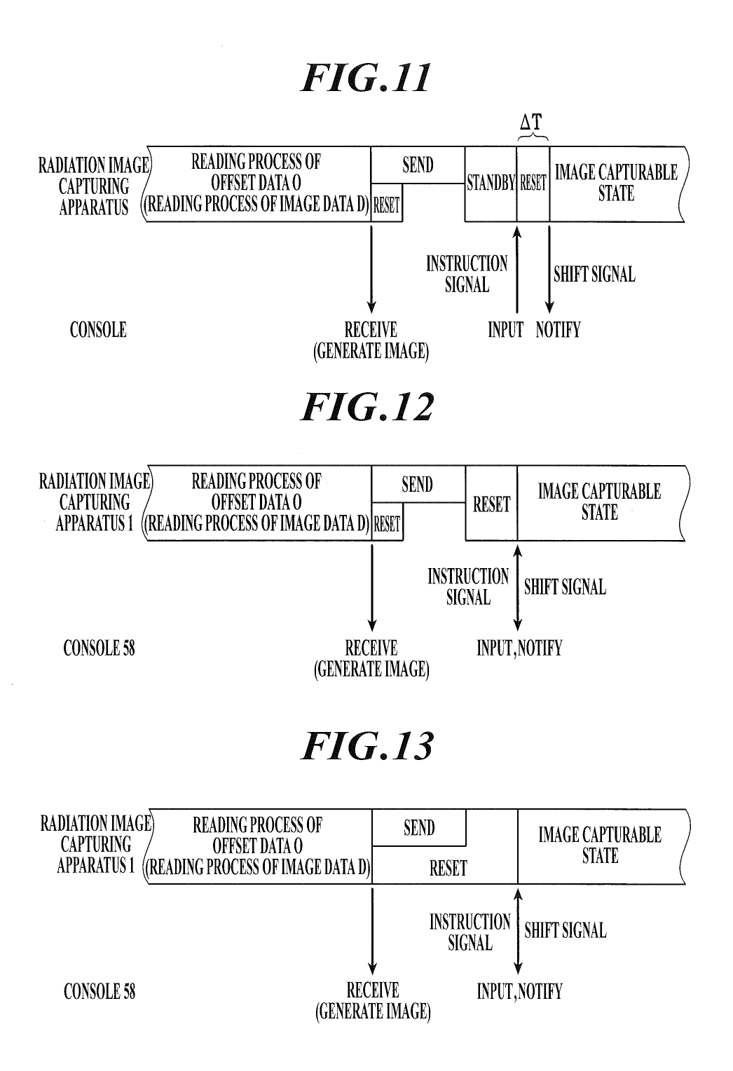

In this case, in a radiation image capturing apparatus of a conventional radiation image capturing system, sending process of the image data D and offset data O to the console is performed as shown in FIG. 11 when the reading process of offset data O shown in FIG. 10 is finished (or when the reading process of image data D is finished in a case where the reading process of offset data O is performed before the reading process of image data ID), for example. When the image data D and others are sent, the console receives and stores them and may perform a process of creating a radiation image on the basis of the image data D and others at that time.

In the radiation image capturing apparatus, the reset process of each radiation detection element 7 for removing electric charge remaining in each radiation detection element 7 may be performed at the same time as the sending process of image data D and others (see FIGS. 6 and 7). However, the reset process of each radiation detection element 7 in this case is normally stopped every time when the reset process is performed as many times as needed for the purpose of reducing the power consumption or the like as shown in FIG. 11.

When sending of image data D and others is finished, the radiation image capturing apparatus shifts to the standby state until receiving the instruction for the next radiation image capturing from the console, as mentioned above. Then, when an operator selects and inputs image capturing order information for the next image capturing on the console, an image capturing start instruction signal is sent from the console to the radiation image capturing apparatus.

The radiation image capturing apparatus starts the reset process of each radiation detection element 7 to remove dark electric charge and such like existing in each radiation detection element 7 from the point when receiving the image capturing start instruction signal. The reset process of the radiation detection elements 7 approximately takes one to several seconds and this time is the aforementioned waiting time ΔT.

At the time when a predetermined reset process is finished (that is, at the time when the waiting time ΔT elapsed), the radiation image capturing apparatus shifts to a process for the next radiation image capturing (see “image capturing possible” in the drawings) and at the same time, sends a shift signal indicating that the radiation image capturing apparatus shifts to the process for the next radiation image capturing to the console.

Here, the “process for the next radiation image capturing” in the radiation image capturing apparatus is a process to perform the reading process of image data d for irradiation start detection or leak data d leak and the process to operate the current detection unit or the X-ray sensor for detecting radiation irradiation start by the radiation image capturing apparatus itself in the non-cooperation method as mentioned above, and the same can be applied in the after-mentioned present invention.

In the cooperation method, the radiation image capturing apparatus starts the reset process of each radiation detection element 7 when receiving the image capturing start instruction signal from the console 58 because the reset process of each radiation detection element 7 is performed as the process for the next radiation image capturing.

When receiving a shift signal from the radiation image capturing apparatus, the console notifies an operator such as a radiology technician that the next radiation image capturing can be carried out by displaying “ready for image capturing” or the like on the display section. At that time, the operator is finally allowed to apply radiation to the radiation image capturing apparatus from the radiation source 52 by operating the exposure switch 56 (see FIGS. 4 and 5) of the radiation generator 55 for the next radiation image capturing.

That is, the operator was not able to apply radiation by operating the exposure switch 56 immediately after selecting and inputting the image capturing order information on the console for the next image capturing, and had to wait to apply radiation during the waiting time ΔT which is from inputting of image capturing order information until notification by display or the like indicating that radiation image capturing is possible on the display section of the console.

### [Configuration and Such Like of the Present Invention so as not to Cause the Waiting Time]

Therefore, so as not to cause such waiting time, the control unit 22 of the radiation image capturing apparatus 1 starts the reset process of each radiation detection element 7 and continues the reset process for the next radiation image capturing immediately after a series of processes for obtaining the image data D is finished as described above in the embodiment.

That is, when a series of processes (sending of image data D and others, for example) for obtaining the image data D is finished, the radiation image capturing apparatus 1 of the present invention does not shift to the standby state as the above conventional radiation image capturing apparatus (see FIG. 11) and immediately starts the reset process of each radiation detection element 7 for the next radiation image capturing and continues the reset process until receiving the image capturing start instruction signal as shown in FIG. 12.

Further, as shown in FIG. 13, it is also possible not to stop the reset process of each radiation detection element 7 which is already started after the reading process of offset data O (or the reading process of image data D) is finished and to continue the reset process even after a series of processes for obtaining image data D is finished, for example.

In such configuration, as shown in FIGS. 12 and 13, when an operator such as a radiology technician selects and inputs image capturing order information on the console 58 for the next image capturing and an image capturing start instruction signal is sent to the radiation image capturing apparatus 1 from the console 58, the reset process is already being performed continuously in the radiation image capturing apparatus 1 at that time and thus remaining electric charge is sufficiently removed from the inside of each radiation detection element 7.

Therefore, when the image capturing start instruction signal is sent from the console 58, the control unit 22 of the radiation image capturing apparatus 1 can immediately stop the reset process of each radiation detection element 7 and shift to a process for the next radiation image capturing, and at the same time, the control unit 22 can immediately send a shift signal indicating that the radiation image capturing apparatus 1 shifted to the process for the next radiation image capturing to the console 58.

When receiving the shift signal from the radiation image capturing apparatus 1, the console 58 notifies the operator that the next radiation image capturing is possible (that is, radiation irradiation can be performed) via a notification unit by display or the like indicating that the next image capturing is possible on the display section 58a.

Therefore, the operator is allowed to immediately apply radiation to the radiation image capturing apparatus 1 without waiting for the waiting time ΔT (see FIG. 11) because notification is made by display or the like indicating that radiation image capturing is possible on the display section 58a of the console 58 immediately after the operator such as a radiology technician selects and inputs the image capturing order information on the console 58 for the next image capturing.

Here, when a reset process of each radiation detection element 7 is performed as shown in FIG. 6, the control unit 22 of the radiation image capturing apparatus 1 may continue applying on-voltage to each scanning line 5 from the gate driver 15b even after receiving the image capturing start instruction signal from the console 58 and may send the shift signal when on-voltage is applied to the last line Lx of the scanning lines 5 to perform the reset process (that is, at the time when the reset process of each radiation detection element 7 is finished for one frame of detecting section P), for example.

However, in this configuration as well, the operator is notified by display or the like indicating that radiation image capturing is possible on the display section 58a of the console 58 barely noticing the waiting time ΔT because the waiting time ΔT is within approximately several tens of milliseconds.

Therefore, by a configuration as in the present invention (see FIGS. 12 and 13), notification is immediately made by display or the like indicating that radiation image capturing is possible on the display section 58a of the console 58 when an operator such as a radiology technician selects and inputs image capturing order information on the console 58 for the next image capturing after a series of processes for obtaining image data ID is finished in the radiation image capturing apparatus 1.

Therefore, the operator can apply radiation to the radiation image capturing apparatus 1 at an arbitrary and preferred timing (for example, immediately after the previous image capturing) because the operator is allowed to immediately apply radiation to the radiation image capturing apparatus 1 without being put on hold during the waiting time ΔT (see FIG. 11) after inputting the image capturing order information.

As described above, the control unit 22 of the radiation image capturing apparatus 1 stops the reset process of each radiation detection element 7 and shifts to the process for the next radiation image capturing when an image capturing start instruction signal is sent from the console 58. However, in a case where the reset process of each radiation detection element 7 is performed as process for the next radiation image capturing as in the above-mentioned cooperation method, for example, the reset process of each radiation detection element 7 is continued before and after the image capturing start instruction signal is received from the console 58.

That is, in this case, though the reset process of each radiation detection element 7 as a state for waiting to receive the instruction signal is stopped when an image capturing start instruction signal is sent from the console 58, the reset process of each radiation detection element 7 as a process for the next radiation image capturing is to start subsequently. Therefore, the reset process of each radiation detection element 7 is continued before and after receiving the image capturing start instruction signal from the console 58.

In a case where a reading process of leak data d leak is performed prior to the radiation image capturing and radiation irradiation start is detected on the basis of the leak data d leak which is read out (see WO 2011/135917), each TFT 8 remains off in this state because leak data d leak is read out in a state where off-voltage is applied to each scanning line 5 (see FIG. 8).

Because dark electric charge continues being accumulated in each radiation detection element 7 if each TFT 8 remains off, normally, a reset process of each radiation detection element 7 is performed alternating with the reading process of leak data d leak.

Therefore, though the reset process of each radiation detection element as a state for waiting to receive an instruction signal is stopped when the image capturing start instruction signal is sent from the console 58, the reset process of each radiation detection element 7 as a process for the next image capturing (which is performed alternately with the reading process of leak data d leak) is subsequently started in this case as well. Therefore, the reset process of each radiation detection element 7 is continuously performed before and after receiving the image capturing start instruction signal from the console 58.

As described above, though the control unit 22 of the radiation image capturing apparatus 1 stops the reset process of each radiation detection element 7 and shifts to the process for the next radiation image capturing when an image capturing start instruction signal is sent from the console 58 in the present invention, the present invention also includes a case where the reset process of each radiation detection element 7 is continuously performed before and after receiving the image capturing start instruction signal from the console 58 as a result.

Further, it is also possible to notify that the next radiation image capturing can be performed by sound or light from a speaker, a light emitting unit or the like of the console 58 instead of or in parallel with using the display section 58a of the console 58 (including a console 58 configured as a mobile device or the like) as the notification unit as mentioned above.

Though FIGS. 12 and 13 show a case where radiation irradiation for the next image capturing cannot be received while image data D and others are being sent, in a case where radiation irradiation can be received for the next image capturing while image data D and others are being sent, an image capturing start instruction signal may be sent from the console 58 while image data D and others are being sent. However, in the present invention, an operator such as a radiology technician can immediately apply radiation to the radiation image capturing apparatus 1 even in such case.

As described above, according to a radiation image capturing system 50 and a radiation image capturing apparatus 1 of the embodiment, the radiation image capturing apparatus 1 does not shift to the standby state as the conventional radiation image capturing apparatus when a series of processes for obtaining image data D is finished, and starts and continues the reset process of each radiation detection element 7 for the next radiation image capturing or continuously performs the reset process of each radiation detection element 7 which is already started after a series of processes is performed.

Therefore, the reset process of each radiation detection element 7 is already started when an image capturing start instruction signal is sent from the console 58 in the present invention as opposed to the conventional radiation image capturing apparatus in which the reset process of each radiation detection element 7 is started when an image capturing start instruction signal is sent from the console 58 and a shift signal indicating shift to the process for the next radiation image capturing is sent to the console 58 after the reset process is performed for a certain period of time.

Therefore, it is possible to immediately notify the operator such as a radiology technician that the next radiation image capturing can be performed by the notification unit (for example, the display section 58a) of the console 58 because the radiation image capturing apparatus 1 can immediately shift to a process for the next radiation image capturing and immediately send a shift signal indicating the shift to the console 58 when the image capturing start instruction signal is sent from the console 58.

Therefore, there is no waiting time ΔT (see FIG. 11) as in the conventional radiation image capturing system, and an operator can immediately apply radiation for the next radiation image capturing when a series of processes for obtaining image data D is finished in the radiation image capturing apparatus 1.

Then, the operator can apply radiation one after another to perform radiation image capturing at a preferred timing without being restricted by the waiting time ΔT after a series of processes for obtaining image data D in the radiation image capturing apparatus 1 is finished, and the radiation image capturing system 50 including the radiation image capturing apparatus 1 is not stressful for the operator and has good operability.

In the present invention, the reset process of each radiation detection element 7 is started and continued for the next radiation image capturing or the reset process of each radiation detection element 7 which is already started is continuously performed when a series of processes for obtaining image data D is finished in the radiation image capturing apparatus 1 as described above.

However, the electric power is wasted in the radiation image capturing apparatus 1 if the reset process of each radiation detection element 7 is continued in a case where the image capturing start instruction signal is not sent from the console 58 for a long time after a series of processes is finished.

Therefore, in order to avoid the waste of electric power, the configuration can be such that duration time of the reset process of each radiation detection element 7 after a series of processes is performed is measured, and when an image capturing start instruction signal is not sent from the console 58 after the duration time reaches the predetermined time, the radiation image capturing apparatus once shifts to a standby state similarly as in the conventional radiation image capturing apparatus, for example. It is also possible to supply electric power to the necessary functional sections only and to shift to a so-called sleep state in which power consumption is lower than in the standby state instead of shifting to the standby state.

Also, it goes without saying that the present invention is not limited to the above embodiment and can be changed appropriately as long as the changes are within the scope of the invention.

The entire disclosure of Japanese Patent Application No. 2012-010617 filed on Jan. 23, 2012 including description, claims, drawings, and abstract are incorporated herein by reference in its entirety.

What is claimed is:

1. A radiation image capturing system comprising:
a radiation image capturing apparatus comprising:
a plurality of scanning lines and a plurality of signal lines arranged so as to cross each other;
a plurality of radiation detection elements arranged in a two-dimensional array;
a scanning drive unit which switches a voltage to be applied to the scanning lines between an on-voltage and an off-voltage;
switch units which are connected to the scanning lines so as to discharge electric charges accumulated in the radiation detection elements to the signal lines when the on-voltage is applied;
reading circuits which read out the electric charges discharged to the signal lines; and
a control unit which controls at least the scanning drive unit and the reading circuits to read out the electric charges discharged from the radiation detection elements as image data, and
a console comprising a notification unit, wherein the console sends an image capturing start instruction signal to the radiation image capturing apparatus,
wherein
the control unit of the radiation image capturing apparatus starts or continues a reset process of the radiation detection elements to discharge the electric charges remaining in the radiation detection elements from inside of each of the radiation detection elements for next radiation image capturing when a series of processes for obtaining the image data is finished,
the control unit of the radiation image capturing apparatus stops the reset process of the radiation detection elements, shifts to a process for the next radiation image capturing and sends a shift signal indicating shift to the process for the next radiation image capturing to the console when the image capturing start instruction signal for the next image capturing is sent from the console, and
the console notifies that radiation image capturing is possible via the notification unit when the console receives the shift signal from the radiation image capturing apparatus.

2. The radiation image capturing system of claim 1, wherein the control unit of the radiation image capturing apparatus starts and continues the reset process of the radiation detection elements for the next radiation image capturing when a series of processes up to a reading process of the image data in which the image data is read out from the radiation detection elements is finished.

3. The radiation image capturing system of claim 1, wherein the control unit of the radiation image capturing apparatus starts and continues the reset process of the radiation detection elements for the next radiation image capturing when a series of processes up to a reading process of offset data which is equivalent to offset caused by dark electric charges accumulated in the radiation detection elements is finished after the reading process of the image data in which the image data is readout from the radiation detection elements is finished.

4. The radiation image capturing system of claim 1, wherein the control unit of the radiation image capturing apparatus starts sending the image data to an image processing apparatus and at the same time starts and continues the reset process of the radiation detection elements for the next radiation image capturing when a series of processes for obtaining the image data is finished.

5. A radiation image capturing apparatus comprising:
a plurality of scanning lines and a plurality of signal lines arranged so as to cross each other;
a plurality of radiation detection elements arranged in a two-dimensional array;
a scanning drive unit which switches a voltage to be applied to the scanning lines between an on-voltage and an off-voltage;
switch units which are connected to the scanning lines so as to discharge electric charges accumulated in the radiation detection elements to the signal lines when the on-voltage is applied;
reading circuits which read out the electric charges discharged to the signal lines; and
a control unit which controls at least the scanning drive unit and the reading circuits to read out the electric charges discharged from the radiation detection elements as image data,
wherein
the control unit starts or continues a reset process of the radiation detection elements to discharge the electric charges remaining in the radiation detection elements from inside of each of the radiation detection elements for next radiation image capturing when a series of processes for obtaining the image data is finished, and
the control unit stops the reset process of the radiation detection elements, shifts to a process for the next radiation image capturing and sends a shift signal indicating shift to the process for the next radiation image capturing to a console when an image capturing start instruction signal for the next image capturing is sent from the console.
